(19) United States
(12) Patent Application Publication
(10) Pub. No.: US 2007/0252692 A1
(43) Pub. Date: Nov. 1, 2007

(54) WIRELESS ENVIRONMENT SENSOR DATA SYSTEM AND METHOD

(75) Inventors: Patrick WALLACE, San Jose, CA (US); Joshua ROSENTHAL, San Jose, CA (US)

Correspondence Address: INGRASSIA FISHER & LORENZ, P.C., 7150 E. CAMELBACK, STE. 325, SCOTTSDALE, AZ, 85251, US

(73) Assignee: SYMBOL TECHNOLOGIES, INC., Holtsville, NY (US)

(21) Appl. No.: 11/560,449

(22) Filed: Nov. 16, 2006

Related U.S. Application Data
(60) Provisional application No. 60/797,018, filed on May 1, 2006.

(51) Int. Cl. G08B 1/08

(52) U.S. Cl. 340/539.26

(57) ABSTRACT

A wireless environment sensor data system and method for a wireless local area network (WLAN) is disclosed. Wireless environment sensor raw data is collected from a wireless sensor by a wireless data collector device in the WLAN. The environment sensor raw data is then sent to a wireless switch via an Ethernet switch in the WLAN. The wireless switch sends the raw data to a destination in WLAN infrastructure where the raw data is processed.

### CROSS-REFERENCE TO RELATED APPLICATION(S)

This application claims the benefit of U.S. provisional patent application Ser. No. 60/797,018, filed May 1, 2006.

### TECHNICAL FIELD

Embodiments of the present invention relate generally to wireless data systems suitable for use in a wireless local area network (WLAN). More particularly, embodiments of the present invention relate to a wireless environment sensor data system and method.

### BACKGROUND

There has been a dramatic increase in demand for mobile connectivity solutions utilizing various wireless components and WLANs. This generally involves the use of wireless access base stations that communicate with mobile devices using one or more RF channels. A WLAN may operate in accordance with one or more of the IEEE 802.11 standards. WLANs can give clients the ability to “roam” or move from place to place without being connected by wires. In the context of a WLAN, the term “roaming” describes the act of moving between wireless access devices, which may be stand-alone wireless access points or wireless access ports that cooperate with one or more wireless switches located in the WLAN.

Wireless sensor devices can be utilized to detect any number of environmental conditions, such as temperature, humidity, wind velocity, barometric pressure, hazards of toxic gases, smoke and fire, violations of security by audible sound, ultra-sonic sound or infra-red signature, and the like. The sensor raw data collected by such devices is transmitted, via wireless data communication links and/or via wired links, to respective processing components for further handling. Conventional wireless environment sensors generally have internal processing devices and relay processed data to a host terminal such as a repeater. Wireless switching systems for WLANs generally do not sense their surrounding environments.

### BRIEF SUMMARY

A wireless environment sensor data system and method as described herein can be deployed to support a wireless local area network (WLAN). A wireless environment sensor data system as disclosed herein enables communication with compliant environmental sensor devices. Systems may include a data collector device configured to collect wireless environment sensor raw data and a wireless switch configured to process the wireless environment sensor raw data (which is typically realized as digital bits). The method receives wireless environment sensor raw data, may store/collect the wireless environment sensor raw data to obtain collected raw data, sends the collected raw data to a wireless switch via an Ethernet switch and processes the collected raw data at the wireless switch to obtain processed data. The method then sends the processed data to a destination in the WLAN infrastructure via the wireless switch. The destination then further analyzes the processed data to extract required/desired information from the sensor collected data.

In another embodiment, the destination may also remotely configure the sensor as needed to secure or adjust data collection protocols through the medium of the WLAN network.

The above and other features may be carried out in one embodiment by a wireless environment sensor data system for a WLAN. The wireless environment sensor data system allows sensing, collecting and limited processing wireless environment sensor data. In this embodiment, one or more environment-related sensors are incorporated into the WLAN. Such sensors might sense, for example, events related to environmental conditions, toxicity and safety conditions, or security conditions.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a schematic representation of a wireless environment sensor data system in a WLAN environment;

FIG. 2 is a schematic representation of a wireless environment sensor data collector device; and

FIG. 3 is a flow chart that illustrates a wireless environment sensor data process in a WLAN supported by the wireless environment sensor data system.

### DETAILED DESCRIPTION

The following detailed description is merely illustrative in nature and is not intended to limit the embodiments of the invention or the application and uses of such embodiments. Furthermore, there is no intention to be bound by any expressed or implied theory presented in the preceding technical field, background, brief summary or the following detailed description.

Embodiments of the invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the invention may be practiced in conjunction with any number of data transmission protocols and network configurations, and that the system described herein is merely one example embodiment of the invention.

For the sake of brevity, conventional techniques related to WLANs, data transmission, data processing, signaling, network control, wireless access device operation, wireless switch operation, environmental sensor operation, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in a practical embodiment.

The following description refers to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically.

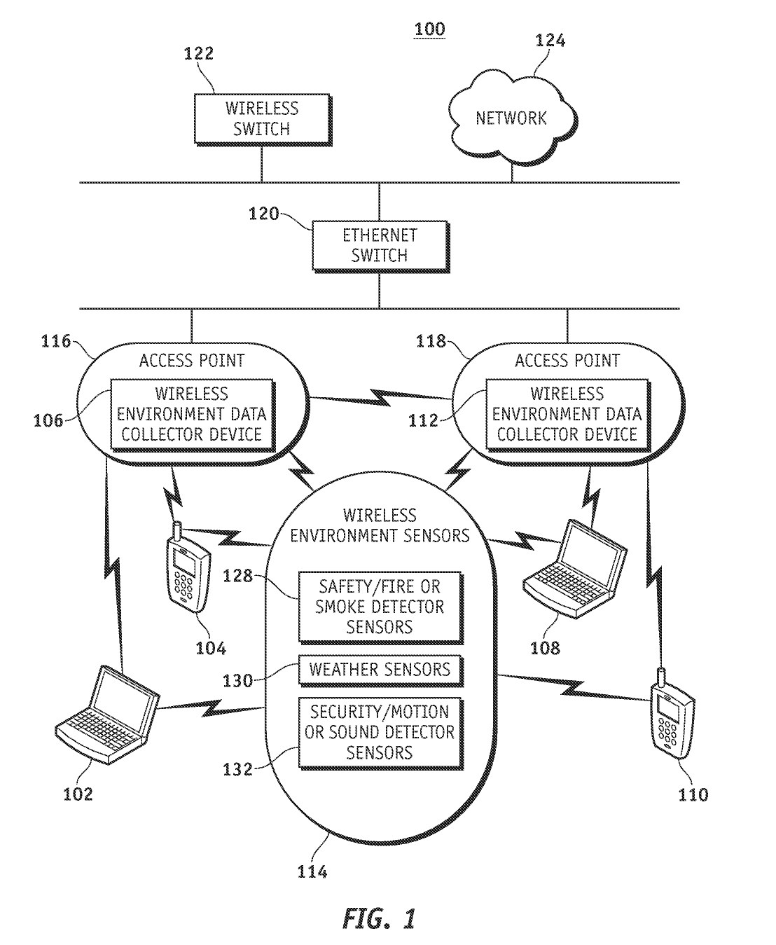

FIG. 1 is a schematic representation of a wireless environment sensor data system 100 in a WLAN environment configured in accordance with one embodiment of the invention. The system 100 generally includes wireless clients (identified by reference numbers 102, 104, 108, and 110), a number of wireless access points (identified by reference numbers 116 and 118), wireless environment sensors 114, an Ethernet switch 120, and a wireless switch 122. In this embodiment, access point 116 includes a wireless environmental data collector device 106, and access point 118 includes a wireless environmental data collector device 112. The system 100 may also include or communicate with any number of additional network components, such as a traditional local area network (LAN). In FIG. 1, such additional network components are generally identified by reference number 124. A practical embodiment can have any number of wireless switches, each supporting any number of wireless access points, and each wireless access point supporting any number of wireless clients. Indeed, the topology and configuration of system 100 can vary to suit the needs of the particular application and FIG. 1 is not intended to limit the application or scope of the invention in any way.

The wireless clients are wireless devices that can move around system 100 and communicate with network components 124 via wireless access points 116/118. It is desirable to utilize a WLAN to provide data to its clients. For example, it is desirable to provide wireless sensor data due to environmental changes (such as rain) to WLAN clients and/or to other clients via network components 124. Having knowledge of the environmental changes may, for example, allow companies to change their sales strategy for a particular product accordingly. For example, if it rains in an area were a particular store is located, order more umbrellas for that store.

In this example, wireless access points 116/118 are realized as wireless “thin” devices that rely on the network intelligence and management functions provided by wireless switch 122. Thus, wireless access points 116/118 may need to rely upon wireless switch 122 for operation. Wireless access points having conventional features that can be incorporated into wireless access points 116/118 are available from Symbol Technologies, Inc. For this example embodiment, access points 116/118 may be weather sealed in a suitable manner for outdoor use and in accordance with anticipated operating conditions. The AP may be sealed for weather using numerous available weather-tight enclosures available over-the-counter, or by the use of specially designed purpose built enclosures of plastic or metal or both. A weather sealed enclosure has the advantage of being mounted in an un-protected environment away from conventional structures. Expanding on the concept of a weather-tight enclosure, one could also design an intrinsically safe enclosure (explosion proof) for use in hazardous environments such as petroleum refineries, or chemical plants. Such enclosures in addition to being weather-sealed, are designed to completely remove the enclosed base station from the surrounding space. Briefly, a wireless access point as described herein is suitably configured to receive data from wireless clients 102/104/108/110 and from the environment sensors 114 over wireless links. Once that data is captured by the wireless access points 116/118, the data can be routed for communication within system 100. For example, the data can be encapsulated into a packet format compliant with a suitable data communication protocol. In the example embodiment, data is routed within system 100 using conventional Ethernet 802.3 addressing (including standard Ethernet destination and source packet addresses).

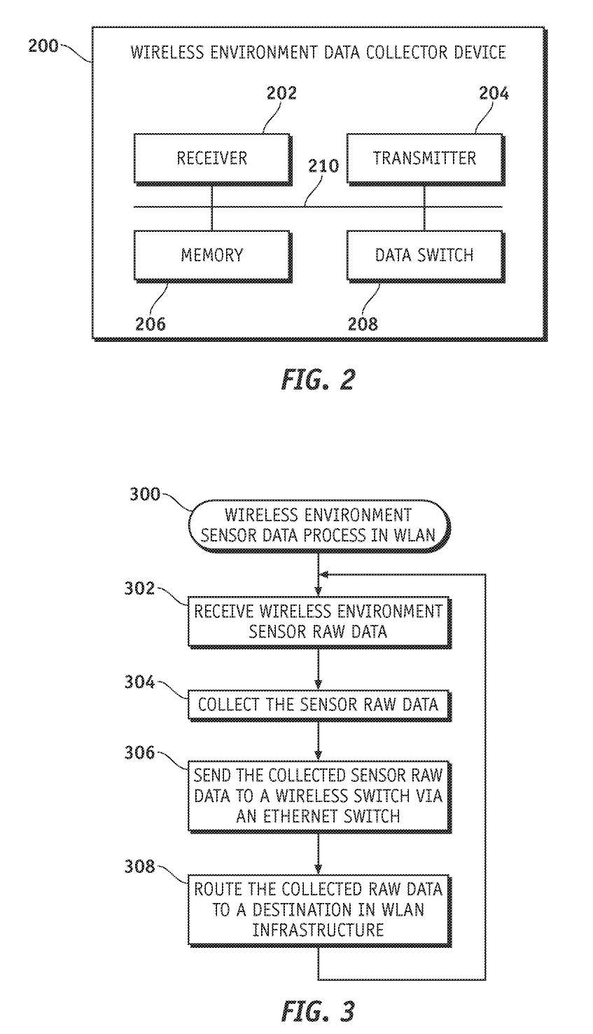

In this example embodiment, each wireless environment data collector device 106/112 is coupled to the respective access point 116/118 and is suitably configured to receive and store wireless environment sensor raw data (e.g., in digital bit format). The data collector device 106/112 may also be, without limitation, imbedded in a mobile client device (i.e., a wireless laptop 102/108, a mobile phone 104/110, or the like). In this regard, the wireless environment sensor raw data may be received from the environment sensors 114 by each data collector device 106/112 imbedded in each mobile client device 102/108/104/110. The mobile client devices 102/108/104/110 may then send the environment sensor raw data to the access points 116/118 using Ethernet data protocol 802.3. The data collector device may also be, without limitation, part of a mesh network, where a mesh network is a wireless network that allows data forwarding between wireless clients (for example, the access point 118 may forward data to access point 116 via wireless links and then to the Ethernet switch 120) using the Ethernet data protocol 802.3. In this regard, the data collector device may be without limitation, residing in an access point 116/118 or in a mobile client device 102/108/104/110 that is part of the mesh network, or may be a stand alone device as part of the mesh network, in communication with access points 116/118 and/or mobile client devices 102/108/104/110, suitably located in a physical location (such as on a light pole). In a mesh network, the wireless environment sensor raw data may be received from the environment sensors 114 by each data collector device 106/112 and sent to the access points 116/118 and/or the mobile client devices 102/108/104/110 using Ethernet data protocol 802.3. The data collector device 116/118 is explained in more detail in the context of FIG. 2 below.

As described herein, wireless environmental data collector devices 106/112 are suitably configured to communicate with environment sensor devices 114. An environment sensor can be utilized by the wireless access points 116/118 and/or by other network components that are coupled to the wireless access points 116/118 via the WLAN. In this embodiment, the environment sensors 114 may be, without limitation, located remotely in the WLAN or may be located locally in the wireless access points 116/118. Such environment sensors 114 might sense, without limitation, for example, relative humidity, pressure, temperature, wind speed, smoke and the like. The sensors 114 are suitably configured to generate sensor data values that indicate the measured quantities in a desired format. For example, a temperature sensor generates data indicative of temperature readings (in degrees Fahrenheit or Celsius), a wind speed sensor generates data indicative of a wind velocity (in, e.g., miles per hour), and a relative humidity sensor and smoke sensor generate data indicative of a percentage value between 0% and 100%.

Ethernet switch 120 is configured to receive the wireless environment sensor data and transmit the data to the WLAN wireless switch via the WLAN wired network. Wireless switch 122 is coupled to the Ethernet switch 120, which is in turn coupled to wireless access points 116/118. In practice, wireless switch 122 communicates with wireless access points 116/118 via Ethernet switch 120. A given wireless switch can support any number of wireless access points, i.e., one or more wireless access points can be concurrently adopted by a single wireless switch (in the example embodiment, a wireless access point can be adopted by only one wireless switch at a time). According to an example embodiment of the invention, the wireless switch 122 is configured to receive and route the wireless environment sensor raw data. The wireless switch 122 also provides security protocols between remote environment sensors and application computers on the LAN to ensure the collected environment sensor raw data is secure and protected. Moreover, the wireless switch 122 ensures the routed environment sensor raw data is managed in seamless fashion for the user, selecting quick and efficient pathways between the environment sensors 114 and the application computers on the LAN. The wireless switch 122 may be based upon any WLAN wireless switch product.

FIG. 2 is a schematic representation of a wireless environment sensor data collector device 200 configured in accordance with an embodiment of the invention. The wireless environment data collector device 200 collects data indicative of environmental conditions from environmental sensors in a WLAN environment. The wireless environmental data collector device 200 may be coupled to the wireless access points 116/118 or other elements in a WLAN environment as explained in the context of FIG. 1 above. The wireless environment data collector device 200 generally includes a receiver module 202, a transmitter module 204, a memory module 206, and a data switch 208. These and other elements of wireless environment data collector device 200 may be interconnected together using a bus 210 or any suitable interconnection arrangement. Such interconnection facilitates communication between the various elements of wireless environment data collecting device 200.

The receiver module 202 is in communication with the WLAN infrastructure and is configured to receive the wireless environment sensor raw data. The receiver module may cooperate with a suitably configured RF antenna arrangement (not shown) that supports the particular wireless communication protocol and modulation scheme. In the example embodiment, receiver module 202 is configured to support WLAN connectivity in compliance with established IEEE specifications, such as one or more of the variations of IEEE 802.11. The receiver module 202 may be configured to support alternate or additional wireless data communication protocols, including future variations of 802.11 such as 802.11n.

The memory module 206 is coupled to and is in communication with the receiver module 202. The memory module 206 may be any suitable data storage area that is formatted to support the operation of the data collector device 200. Memory module 206 is configured to store, maintain, and provide data as needed to support the functionality of the wireless environmental data collector device 200. The data may include, without limitation, values that indicate weather data such as relative humidity, wind speed, temperature, and pressure, data related to safety such as data indicative of fire and smoke, and data related to security such as audible sounds, ultra-sonic sounds, infra-red signatures and motion. In practical embodiments, memory module 206 may be realized as RAM memory, flash memory, ROM memory, EPROM memory, EEPROM memory, registers, a hard disk, a removable disk, a CD-ROM, or any other form of storage medium known in the art. The memory module 206 may be coupled to the data switch 208 to store the data.

The transmitter module 204 is coupled to and is in communication with the memory module 206. The transmitter module is configured to send the wireless environment sensor raw data via an Ethernet switch to a wireless switch in the WLAN environment. The transmitter module 204 may cooperate with a suitably configured RF antenna arrangement (not shown) that supports the particular wireless communication protocol and modulation scheme. In the example embodiment, the transmitter module 204 is configured to support WLAN connectivity in compliance with established IEEE specifications, such as one or more of the variations of IEEE 802.11. The transmitter module 204 may be configured to support alternate or additional wireless data communication protocols as explained above.

The data switch 208 may be coupled to the transmitter 206. The data switch 208 is configured to control transmission of the wireless environment sensor raw data in response to a request by the WLAN infrastructure as explained in the context of FIG. 3 below.

Briefly, the environmental sensors 114 send raw data (digital bits) instead of processed data to the wireless environment data collector device 106, the data collector device 106 receives and stores the raw data and sends the raw data to the wireless switch 122, the wireless switch 122 routes the raw data to a destination in the WLAN infrastructure (i.e., an application computer in a corporate office). Sending raw data instead of processed data allows utilizing application computers with faster and more powerful processing capabilities at the destination. Also, the sensor is then free to devote all processing power to collecting and transmitting samples to the data collector device. Moreover, because collecting data requires very little processing power, the electronics of the sensor may be less expensive and permit a more pervasive sensing network. Additionally, by sending raw data, a significant amount of data may be processed utilizing less bandwidth. For example, as an application processes the data into information, it would need to access and upload the data from the sensor for every processing task undertaken. In this regard, the data bandwith available on the WLAN or LAN would be reduced by the complexity and size of the application being shared by the environment sensors 114. Thus, by sending the raw data instead of processed data to the environment data collector device 106 and to the wireless switch 122, less bandwidth is utilized. The environment sensors 114 may include, without limitation: a safety sensor 128 for detecting smoke/CO₂/fire conditions, a weather sensor 130 for detecting weather conditions 130, and a security sensor 132 for detecting data indicative of building security conditions such as motion and sound.

FIG. 3 is a flow chart that illustrates a wireless environment sensor data process 300 in a WLAN supported by the wireless environment sensor data system. The various tasks performed in connection with process 300 may be performed by software, hardware, firmware, or any combination thereof. For illustrative purposes, the following description of process 300 may refer to elements mentioned above in connection with FIGS. 1-2. In embodiments of the invention, portions of process 300 may be performed by different elements of the described system, e.g., environmental sensor devices, access points, wireless environment data collector devices, an Ethernet switch and a wireless switch. It should be appreciated that process 300 may include any number of additional or alternative tasks, the tasks shown in FIG. 3 need not be performed in the illustrated order, and process 300 may be incorporated into a more comprehensive procedure or process having additional functionality not described in detail herein.

Process 300 may begin by receiving wireless environment sensor raw data from environment sensor devices (task 302). The environmental sensors transmit the environment sensor raw data to a wireless environment data collector device using the conventional Ethernet 802.3 protocol. The wireless environment data collector device may be, without limitation, residing in an access point, be part of a mesh network, or be imbedded in a mobile unit as explained above. The environment sensor raw data is then collected in the wireless environment data collecting device (task 304). The collected environment sensor raw data is then sent from the access point to a wireless switch via an Ethernet switch (task 306), in response to a request by the WLAN infrastructure. When the WLAN infrastructure is ready to receive more data, it sends a request to the data collector device, and the data collector device opens its data switch (see FIG. 2) to send a portion of the collected data to the wireless switch. Otherwise, the data switch remains closed and no data is sent from the data collector device to the wireless switch. This data switching mechanism allows load (bandwidth) balancing in the WLAN which results in an efficient use of available bandwidth. The wireless switch then routes the environment sensor raw data (task 308) to a destination in a WLAN environment. For example, the wireless switch may route the raw data to an application computer on the LAN (e.g., at a corporate office) that have the applications for processing the environment sensor raw data. The processed data may be, without limitation, data indicative of level of humidity, amount of rain fall, amount of smoke, wind speed, and the like. The processed data may be used for statistical analysis. For example, the processed data may used, without limitation, to determine sales traffic at a store affected by rain, wind, humidity, and the like. The processed data may also be used to indicate a warning such as a weather warning, a security warning, or a safety warning in case of, for example, an upcoming storm, fire, trespassing and the like. Processing the raw data at the destination (instead of the environment sensors) reduces bandwidth consumption as explained in the context of FIG. 1 above.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention, where the scope of the invention is defined by the claims, which includes known equivalents and foreseeable equivalents at the time of filing this patent application.

What is claimed is:

1. A wireless environment sensor data system for a wireless local area network (WLAN) infrastructure, the system comprising:
a data collector device configured to collect wireless environment sensor raw data; and
a wireless switch configured to route the wireless environment sensor raw data.

2. A system according to claim 1, wherein the data collector device is coupled to an access point in the WLAN infrastructure.

3. A system according to claim 2, wherein the access point is weather sealed.

4. A system according to claim 2, wherein the access point is part of a mesh network.

5. A system according to claim 1, wherein the data collector device is imbedded in a mobile wireless device.

6. A system according to claim 5, wherein the mobile wireless device is part of a mesh network.

7. A system according to claim 1, wherein the data collector device comprises:
a receiver module in communication with the WLAN infrastructure, wherein the receiver module is configured to receive the wireless environment sensor raw data;
a memory module coupled to and in communication with the receiver module, wherein the memory module is configured to store the wireless environment sensor raw data;
a transmitter module coupled to and in communication with the memory module, wherein the transmitter module is configured to send the wireless environment sensor raw data to the wireless switch via an Ethernet switch; and
a data switch configured to control transmission of the wireless environment sensor raw data in response to a request by the WLAN infrastructure.

8. A system according to claim 7, wherein:
the receiver module is in compliance with IEEE 802.11 specifications; and
the transmitter module is in compliance with IEEE 802.11 specifications.

9. A method for processing wireless environment sensor data for a wireless local area network (WLAN) infrastructure, the method comprising:
receiving wireless environment sensor raw data;
collecting the wireless environment sensor raw data to obtain collected raw data;
sending the collected raw data to a wireless switch; and
routing the collected raw data to a destination in the WLAN infrastructure via the wireless switch.

10. A method according to claim 9, wherein the sending step further comprises sending the collected raw data in response to a request by the WLAN infrastructure.

11. A method according to claim 9, wherein the collected raw data is processed at the destination.

12. A method according to claim 11, further comprising performing statistical analysis on the processed data.

13. A method according to claim 12, wherein the statistical analysis determines effects of weather conditions on sales in particular stores.

14. A method according to claim 9, further comprising indicating a warning based on the processed data.

15. A method according to claim 14, wherein the warning comprises at least one of:
a weather warning;
a security warning;
a safety warning.

16. A wireless environment sensor data system for a wireless local area network (WLAN) infrastructure, the system comprising:
a receiver module in communication with the WLAN infrastructure, wherein the receiver module is configured to receive the wireless environment sensor raw data;
a memory module coupled to and in communication with the receiver module, wherein the memory module is configured to store the wireless environment sensor raw data;
a transmitter module coupled to and in communication with the memory module, wherein the transmitter module is configured to send the wireless environment sensor raw data to an Ethernet switch;
a wireless switch configured to receive the wireless environment sensor raw data from the Ethernet switch; and
a data switch configured to control transmission of the wireless environment sensor raw data to the wireless switch based upon a request by the WLAN infrastructure.

17. A system according to claim 16, further comprising an environment sensor in communication with the WLAN, wherein the environment sensor is configured to send wireless environment sensor raw data to the receiver module.

18. A system according to claim 17, wherein the environment sensor is a weather sensor.

19. A system according to claim 18, wherein the weather sensor comprises:
a relative humidity sensor;
a pressure sensor;
a temperature sensor; or
a wind speed sensor.

20. A wireless system according to claim 17, wherein the environment sensor is a security sensor.

21. A wireless system according to claim 20, wherein the security sensor comprises a motion detector sensor.

22. A wireless system according to claim 17, wherein the environment sensor is a safety sensor.

23. A wireless system according to claim 22, wherein the safety sensor comprises a smoke detector sensor.

24. A system according to claim 16, wherein the wireless switch is further configured to send raw data to a destination in the WLAN infrastructure.
